(19) United States
(12) Patent Application Publication
(10) Pub. No.: US 2003/0010233 A1
(43) Pub. Date: Jan. 16, 2003

(54) Intaglio printer

(76) Inventor: Johannes Georg Schaede, Wurzburg (DE)

Correspondence Address: Douglas R Hanscom, Jones Tullar & Cooper, Eads Station, PO Box 2266, Arlington, VA, 22202, US

(21) Appl. No.: 10/169,765

(22) PCT Filed: Dec. 16, 2000
(86) PCT No.: PCT/DE00/04504

(30) Foreign Application Priority Data
Jan. 25, 2000 (DE) 10002674.5
May 25, 2000 (DE) 10025996.0

(51) Int. Cl. B41F 9/00

(52) U.S. Cl. 101/153

(57) ABSTRACT

In addition to a form cylinder (2) and a printing cylinder (1), an intaglio printer has at least one screen-printing cylinder (7) for transferring a screen printing ink to the form cylinder.

The invention relates to an intaglio printer according to the preamble to claim 1.

EP 03 43 106 A2 has disclosed a printer with an engraved intaglio printing plate, which is disposed on a form cylinder, and a printing cylinder, in which the engraved intaglio printing plate can be simultaneously used as a wet offset printing plate for an additional offset printing unit.

A printer with an intaglio printing unit that has a form cylinder and a printing cylinder is also known from EP 03 51 366 B1. In this printer, the intaglio printing unit is combined with an indirectly functioning printer unit from which sheets printed by it are fed with the aid of an interposed sheet-feeding apparatus.

Printers of this kind permit superimposed printing with various techniques on the same print stock with a high degree of register preservation. They are therefore preferred for the printing of documents that require a high degree of counterfeit prevention such as banknotes, securities, identification documents, etc.

EP 08 64 421 A1 describes a printer with ink application devices that can be swapped out for different printing processes.

EP 05 63 007 A1 discloses an intaglio printer whose plate cylinder has an additional screen printing cylinder disposed against it, in addition to the master cylinder that is disposed against the cylinder.

DE 197 46 268 A1 discloses the application of lacquers of different viscosities by means of different printing processes.

The object of the invention is to produce an intaglio printer.

The object is attained according to the invention by the characteristics of claim 1.

The advantages that can be achieved with the invention are comprised particularly in the fact that it permits tactilely discernible features to be printed in a simple fashion and with a high degree of register preservation in relation to other printing motifs. The affixing of such tactilely discernible motifs is particularly desirable in monetary bills in order to also permit visually impaired people to be able to reliably recognize banknotes and to differentiate between their various denominations.

The printing plate of the form cylinder of such a machine preferably has recesses, which can contain not only printing ink, but can also have screen printing ink intentionally introduced into them, which is then printed with a profile that corresponds to the form of the recess.

The intaglio printing process executed with the printer is preferably a collecting printing process, i.e. there is a collecting cylinder to which different printing inks to be printed are respectively applied one after the other, preferably with the aid of master cylinders, and the entire intaglio printed motif thus produced is transferred to the print stock in a single passage through the nip.

According to a first embodiment, the screen printing cylinder is disposed against the form cylinder. In terms of the production direction, it can be disposed after a wiping device, which is intrinsically known for intaglio printing, so that the screen printing process occurs essentially uninfluenced by the intaglio printing. The screen printing cylinder, however, can also be disposed against the form cylinder before such a wiping device so that the screen printing ink is wiped in the same way as the printing ink.

According to a second embodiment, the screen printing cylinder is disposed against the collecting cylinder and applies the screen printing ink to it first.

Exemplary embodiments of the invention are shown in the drawings and will be described in detail below.

FIG. 1 shows a schematic section through a first embodiment of the printer;

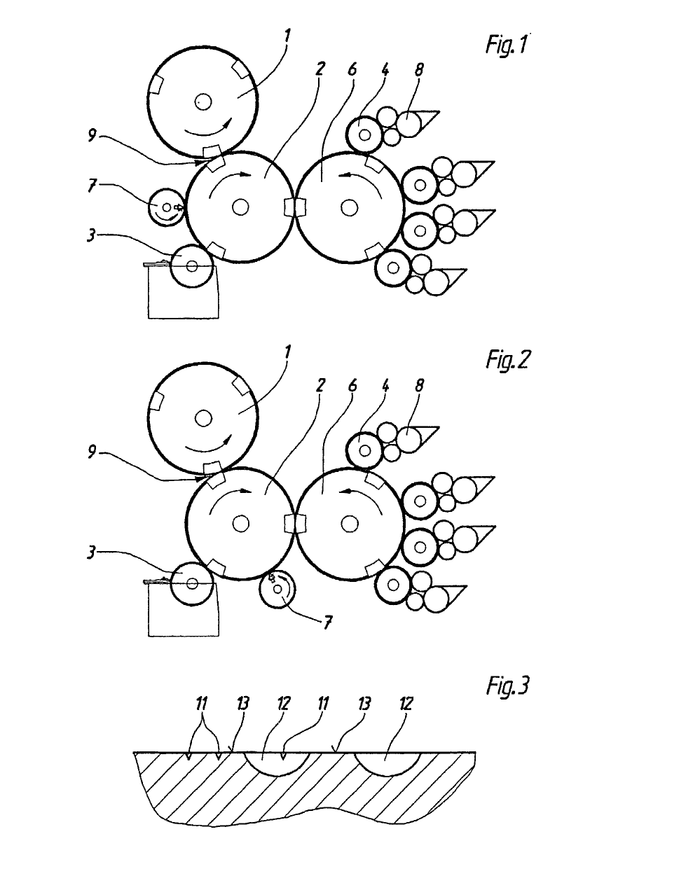

FIG. 2 shows a corresponding section through a second embodiment;

FIG. 3 shows a sectional view of the surface of an intaglio printing plate used in the printer;

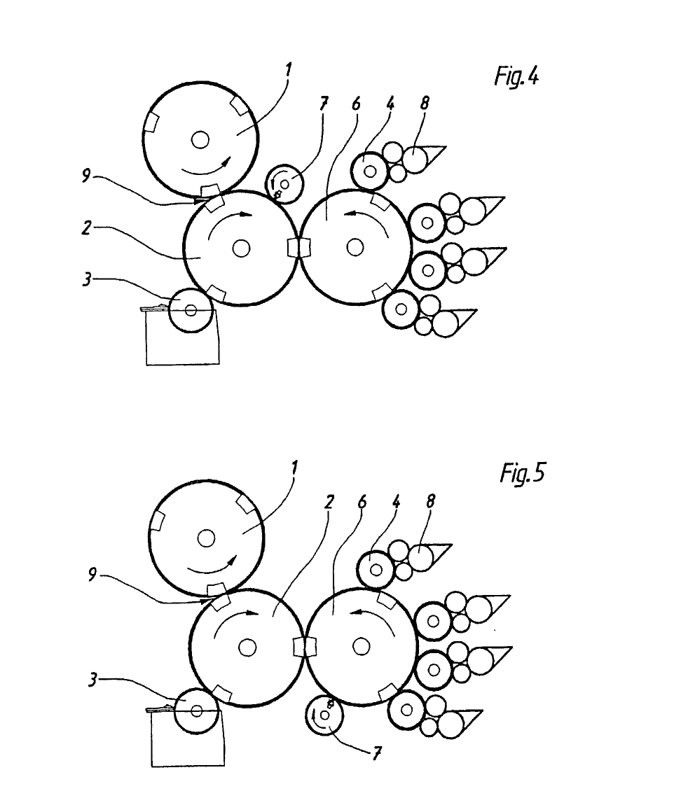

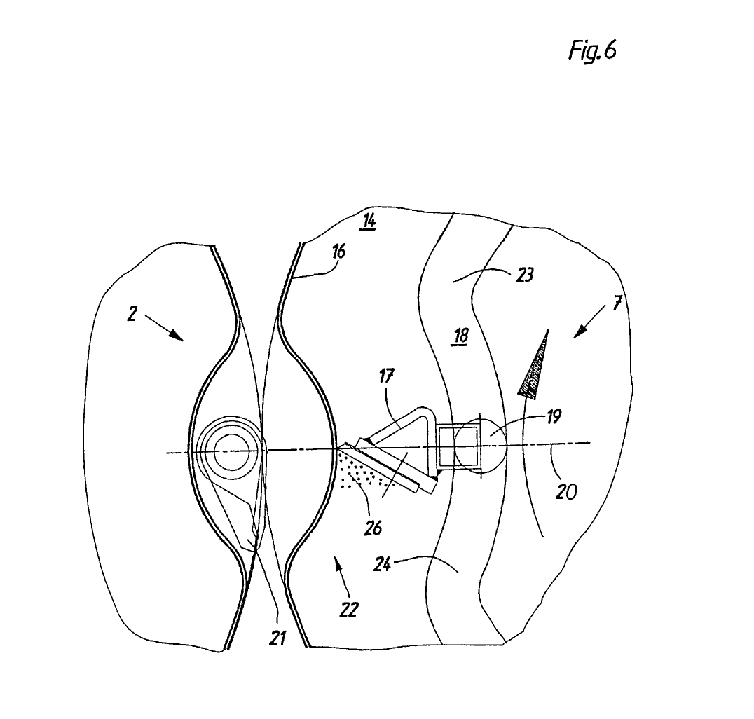

FIGS. 4 and 5 show a section through a third and fourth embodiment of the printer;

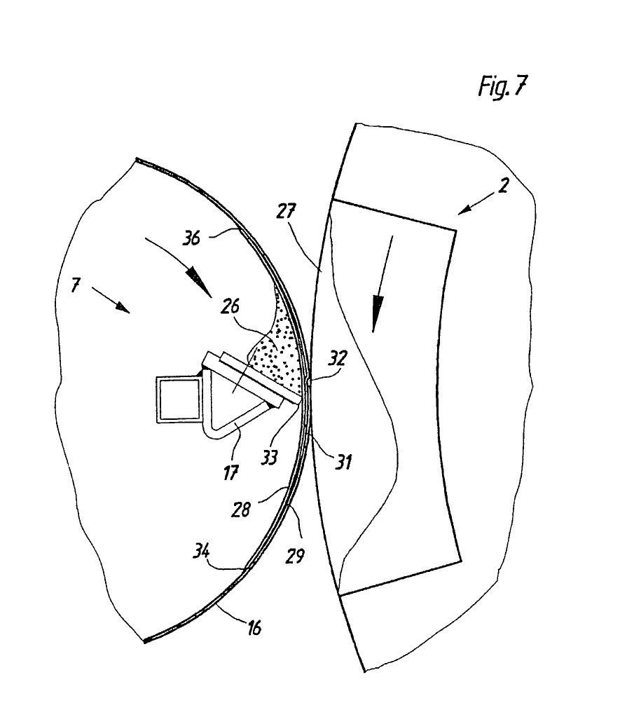

FIGS. 6 and 7 each show a partial section through a screen printing cylinder.

The embodiment of the printer shown in a schematic section in FIG. 1 has a number of inking units 8, which each cooperate with a master cylinder 4 and transfer colored ink to raised areas of the associated master cylinder 4. The master cylinders 4 in turn cooperate with a collecting cylinder 6 to which they transfer the colored ink that they have received from the inking units 8. In this manner, a multicolor pattern is produced on the collecting cylinder 6, whose colored zones respectively correspond to the raised areas of the master cylinders 4.

The collecting cylinder 6 in turn cooperates with a form cylinder 2, e.g. a plate cylinder 2, on which intaglio printing plates are mounted, in particular steel stroke printing plates. These printing plates are inked in contact with the collecting cylinder 6 in accordance with the last inking pattern produced, the printing ink, as it passes through the nip between the plate cylinder 2 and the collecting cylinder 6, being essentially pressed into etched or engraved fine channels, which correspond to a detailed pattern to be printed on the print stock. In the production direction after the nip, i.e. clockwise in FIG. 1, there is a wiping device 3, which removes the remainder of the printing ink, which has not found space in the fine channels, from the surface of the plate cylinder 2.

A screen printing cylinder 7 of a screen printing unit is disposed against the circumference of the plate cylinder 2 after the wiping device 3. This screen printing cylinder 7 applies a screen printing ink to the printing plates of the plate cylinder 2, which have already had the printing ink applied to them and been wiped.

In a subsequent nip 9 in the production direction, between the plate cylinder 2 and a printing cylinder 1, all of the colors applied to the printing cylinder 2 are then printed onto a print stock, in particular onto sheets of paper, which are supplied to the nip 9 by a feeding device that is not shown.

The printer thus produces a complete transfer image on the plate cylinder 2, which image contains all of the colors of the image to be printed and is transferred to the print stock in a single passage through the nip. This apparatus makes it possible to position the screen printing pattern on the printing plates with an extremely high degree of precision in relation to the intaglio printing pattern and thus to achieve a degree of register preservation, which cannot be achieved in two printing actions separated by a step of feeding the print stock.

With this printer, a suitable screen printing ink is selected, which has a high viscosity in comparison to the gravure ink on the surface of the printing cylinder 1 in order to prevent screen printing ink, which is applied to the flat surfaces of the printing plates, from being flattened to an undesirably excessive degree during passage through the nip 9, which could lead to a muddy print image and impairs the tactile discernibility of the screen printing pattern on the finished printed product.

The printer in FIG. 2 differs from the one in FIG. 1 through the placement of the screen printing cylinder 7 in the production direction after the collecting cylinder 6 and before the wiping device 3. FIG. 3 shows a sectional view of a printing plate for use in this printer. Between flat, non-printing regions 13, its surface has fine channels 11 and larger recesses 12. The channels 11 can intersect with the recesses 12. The channels 11 are used for containing printing ink from the collecting cylinder 6, whereas the larger recesses 12 are provided for containing screen printing ink. When the plate cylinder 2, which has been inked with printing ink and screen printing ink, passes through the wiping device 3, the flat regions 13 of the printing plate are freed of ink, while the applied ink remains in the channels 11 and recesses 12 and is transferred to the print stock during passage through the nip 9. As is clear, in this embodiment, the printing plates therefore carry not only the intaglio printing pattern, but also the screen printing pattern. A flattening of regions of the printing plates, which have been inked with screen printing ink during passage through the nip 9, is prevented in this embodiment because the pressure acting in the 9 between the flat regions 13 of the printing plate and the print stock or the printing cylinder 1 prevents the screen printing ink from escaping laterally from the recesses 12. The screen printing ink here is applied to the print stock in a contour, which corresponds to the depth profile of the recesses 12. This permits the production of a very accurate and reproducible print image.

In the modification shown in FIG. 4, a screen printing cylinder 7 is disposed before the collecting cylinder 6 in the production direction. With the use of a printing plate as shown in FIG. 3, this results in the fact that the recesses 12 are already filled with screen printing ink when the inking with printing ink occurs. Since there consequently cannot be any printing ink in the recesses 12 of the printing plate yet when screen printing ink is being applied to it, this largely prevents a color adulteration of the screen printing ink by printing ink on the finished printed product.

FIG. 5 shows another embodiment of the printer, which differs from the above described printer in that the screen printing cylinder 7 is disposed against the collecting cylinder 6 instead of against the plate cylinder 2. It can be situated before the master cylinder 4 in the production direction, as shown in the Fig., or after it. In this embodiment as well, if the screen printing ink applied to the plate cylinder 2 passes through the wiping device 3, then the effects and advantages of this embodiment correspond essentially to those described in relation to the embodiments in FIGS. 2 and 4.

In a partial section, FIG. 6 shows a design of the screen printing cylinder 7, which particularly in the embodiments in FIGS. 1, 2, and 4, is advantageous when the plate cylinder 2 has circumference regions, which diverge from the exact cylindrical form, e.g. due to sheet grippers 21 located there. FIG. 6 shows the region of the nip formed between the screen printing cylinder 7 and the plate cylinder 2. On each of its axial ends, the screen printing cylinder 7 has a support ring 14, whose outer circumference has a screen 16 stretched onto it, e.g. made of silk or polyamide gauze or bronze wire mesh. On the interior of the screen printing cylinder 7, a doctor blade 17 is provided, whose position in the radial direction, i.e. in horizontal direction in the Fig., is controlled by a curved body, in this instance a guide slot 18 embodied at the ends of the screen printing cylinder 7, which a cylindrical guide projection 19 of the doctor blade 17 passes through.

Outside the screen printing cylinder 7, the guide projection 19 is supported at both ends so that it can move along the line 20 connecting the rotation axes of the two cylinders 2; 7. The Fig. shows the doctor blade 17 in a position in which the sheet gripper 21 of the plate cylinder 2 is passing through the nip between the two cylinders 2; 7. Opposite the sheet gripper 21, the screen 16 has a circumference region 22 that is indented radially inward. The guide slot 18 has an arc-shaped section 23, not shown completely in the Fig., which is concentric to the cylindrical outer surface of the screen 16, and an inwardly indented section 24, whose curvature corresponds to that of the circumference section 22. The curvature of the section 24 is selected so that when the section 24 passes by the guide projection 19 during the rotation of the screen printing cylinder 7, the doctor blade 17 is retracted inward so far that exerts only a minimal pressure against the screen 16, which produces no appreciable deformations of the screen 16 in the circumference section 22, or is retracted so far that it loses all contact with the screen 16 and consequently exerts no pressure on its circumference section 22, which could deform this circumference section and damage it during the course of operation. By contrast, when the guide projection 19 is traveling in the section 23 of the guide slot 18, the doctor blade 17 presses against the inside of the screen 16 so that an ink 26 disposed against the doctor blade 17 is pushed through the open regions of the screen 16 and is thus applied to the plate cylinder 2.

The exemplary embodiment of the screen printing cylinder 7 shown in FIG. 7 is suitable for when the plate cylinder 2 does not have any regions that protrude beyond the radius of the printing plates, but perhaps has a concave section, for example a channel 27. The screen printing cylinder 7 in this instance is cylindrical over its entire circumference, without any indented sections. As in the case of the screen printing cylinder 7 from FIG. 6, the screen printing cylinder 7 shown here has a doctor blade 17 disposed inside it, which strokes a paste-like ink 26 through the screen 16 stretched over the screen printing cylinder 7 and thus exerts a radially outward pressure on the screen 16. As long as the screen 16 touches the surface of the plate cylinder 2 during the entire rotation of the screen printing cylinder 7 and the plate cylinder 2, then the plate cylinder 2 provides an opposing pressure, which prevents the doctor blade 17 from deforming the screen 16. In order to also prevent such a deformation in the region of the channel 27, where the screen 16 does not contact the plate cylinder 2, a support element 28 is disposed radially inside the screen 16, which extends in the circumference direction of the screen printing cylinder 7 over a circumference section 29 of the screen 16, which corresponds to the size of the channel 27 on the plate cylinder 2. The support element 28 is a curved, closed plate made of metal or strong plastic, in the form of a cylinder segment.

The support element 28 in this case is attached radially inside the screen 16 and the leading end 31 and trailing end 32 of the screen 16 overlap each other in the circumference section 29 supported by the support element 28. This protects the sensitive connection between the two ends 31; 32 from contact with the doctor blade 17 and therefore from premature wear.

In this design of the screen printing cylinder 7, it is not necessary to guide the doctor blade 17 with a guide body like the guide slot 18 from FIG. 6. In lieu of this, the doctor blade 17 can also be moved slightly in the radial direction, counter to the force of a spring, or can have a lip 33, whose deformation can compensate for slight fluctuations in the radius. In a design of this kind, in order to ease the transition of the doctor blade 17 from the screen 16, onto the support element 28, and back onto the screen 16, and to prevent interruptions in the smooth running of the screen printing cylinder 7, the support element 28 is provided with a leading edge 34 and a trailing edge 36, which are beveled in the circumference direction of the screen printing cylinder 7 and do not extend exactly parallel to a generatrix of the outer surface of the screen printing cylinder 7 or to the lip 33 of the doctor blade 17, but at a slight angle to them.

Reference Numeral List

| | |
|---|---|
| 1 | printing cylinder |
| 2 | form cylinder, plate cylinder |
| 3 | wiping device |
| 4 | master cylinder |
| 5 | — |
| 6 | collecting cylinder |
| 7 | screen printing cylinder |
| 8 | inking unit |
| 9 | nip |
| 10 | — |
| 11 | channel |
| 12 | recess |
| 13 | flat region |
| 14 | support ring |
| 15 | — |
| 16 | screen |
| 17 | doctor blade |
| 18 | guide slot |
| 19 | guide projection |
| 20 | line |
| 21 | sheet gripper |
| 22 | circumference section |
| 23 | section |
| 24 | section |
| 25 | — |
| 26 | ink |
| 27 | channel |
| 28 | support element |
| 29 | circumference section |
| 30 | — |
| 31 | leading end |
| 32 | trailing end |
| 33 | lip |
| 34 | leading edge |
| 35 | — |
| 36 | trailing edge |

1. An intaglio printer with a form cylinder (2) and a printing cylinder (1), characterized in that it has at least one screen printing cylinder (7) for transferring a screen printing ink to the form cylinder (2).

2. The intaglio printer according to claim 1, characterized in that the form cylinder (2) has a steel engraved printing plate.

3. The intaglio printer according to claims 1 or 2, characterized in that the form cylinder (2) is associated with a collecting cylinder (6).

4. The intaglio printer according to claim 3, characterized in that the collecting cylinder (6) is associated with a number of master cylinders (4).

5. The intaglio printer according to claim 4, characterized in that each master cylinder (4) is associated with an inking unit (8).

6. The intaglio printer according to one of the preceding claims, characterized in that the form cylinder (2) is associated with a wiping device (3).

7. The intaglio printer according to claim 6, characterized in that the screen printing cylinder (7) is disposed against the form cylinder (2) before the wiping device (3) in terms of the production direction.

8. The intaglio printer according to claim 6, characterized in that the screen printing cylinder (7) is disposed against the form cylinder (2) after the wiping device (3) in terms of the production direction.

9. The intaglio printer according to claim 3, characterized in that the at least one screen printing cylinder (7) is disposed against the collecting cylinder (6).

10. The intaglio printer according to claim 1, characterized in that the screen printing cylinder (7) has a support element (28), which extends axially against the screen printing cylinder (7) in the region of a section (29) that is limited in the circumference direction.

11. The intaglio printer according to claim 10, characterized in that the support element (28) is disposed radially outside the screen (16).

12. The intaglio printer according to claim 10, characterized in that the support element (28) is disposed radially inside the screen (16).

13. The intaglio printer according to claim 10, characterized in that the support element (28) has leading and trailing edges (34; 36), which extend at an angle to a generatrix of the circumference surface of the screen printing cylinder (7).

14. The intaglio printer according to claim 13, characterized in that the leading and trailing edges (34; 36) have the form of elongated helixes.

15. The intaglio printer according to claim 10, characterized in that the support element (28) is impermeable to ink (26).
